(19) United States
(12) Patent Application Publication
(10) Pub. No.: US 2006/0107707 A1
(43) Pub. Date: May 25, 2006

(54) Shaft lock system

(76) Inventors: Robert L. Vaughn, Orange City, FL (US); Matthew D. Vaughn, Orange City, FL (US)

Correspondence Address: EDWARD M. LIVINGSTON, PA, 963 TRAIL TERRACE DRIVE, NAPLES, FL, 34103, US

(21) Appl. No.: 10/994,798

(22) Filed: Nov. 22, 2004

(51) Int. Cl. E05B 13/00; E05B 73/00

(52) U.S. Cl. 70/18; 70/203; 70/212

(57) ABSTRACT

A shaft-lock system has a mechanism-shaft clamp (1) with a first clamp jaw (2) hinged to a second clamp jaw (3) proximate a clamp pivot (4) that is disposed oppositely from a clamp lock (5). The first clamp jaw and the second clamp jaw are articulated for enclosing a mechanism shaft (6) cooperatively. The clamp lock includes a first-jaw indentation (8) that is positioned on a lock end of the first clamp jaw for being juxtaposed to a second-jaw extension (9) in a closed mode of the mechanism-shaft clamp. The first-jaw indentation includes an indentation aperture (10) and the second-jaw extension includes an extension aperture (11). The extension aperture and the indentation aperture are articulated for receiving a lock shackle (12). A clamp jaw includes shackle-guard walls (13) for guarding the lock shackle. The shaft-lock system includes a lock-shaft clamp (17) on the first clamp jaw and the second clamp jaw. The lock-shaft clamp is articulated for receiving a lock shaft (22) for locking the lock shaft to the mechanism shaft.

### BACKGROUND OF THE INVENTION

This invention relates to a system for unlockable locking of shafts of mechanisms in modes of protection of the mechanisms from unwanted access to the mechanisms.

Shaft-lock systems are widely known and used. None, however, are known to be capable of locking a shaft clamp to a mechanism shaft in a manner that prevents unwanted access to a shackle of a padlock for the shaft-lock system in a manner taught by this invention.

Related but different prior art is known to include the following:

| PATENT NUMBER | INVENTOR | DISCLOSURE DATE |
|---|---|---|
| U.S. Pat. No. 1,295,689 | Byors | Feb. 25, 1919 |
| U.S. Pat. No. 1,358,681 | Parker | Nov. 9, 1920 |
| U.S. Pat. No. 1,383,904 | Brower | Jul. 5, 1921 |
| U.S. Pat. No. 1,498,772 | Anderson | Jun. 24, 1924 |
| U.S. Pat. No. 5,782,115 | Judy | Jul. 21, 1998 |
| U.S. Pat. No. 6,434,982 B1 | Rowland | Aug. 20, 2002 |
| U.S. Pat. No. 2003/0106348 A1 | Nilges | Jun. 12, 2003 |
| U.S. Pat. No. 6,626,016 B2 | Nilges | Sep. 30, 2003 |
| U.S. Pat. No. 6,705,137 B2 | Saladin et al. | Mar. 16, 2004 |

The first four cited references, U.S. Pat. Nos. 1,295,689, 1,358,681, 1,383,904 and 1,498,772, are restricted to mechanism shafts of cranks of pre-starter-motor cars being locked to front structure of the pre-starter-motor cars and have no padlock protection.

Above cited U.S. Pat. No. 5,782,115 is limited to a housing with a notched bottom, an unprotected locking bar, and a chain to which Applicant's invention is not limited.

Above cited U.S. Pat. No. 6,434,982 B1 is limited to a rectangular steel box hinged to an L-shaped main wall and a key-operated metal locking cylinder to which Applicant's invention is not limited.

Above-cited US Application No. and resulting U.S. Pat. No. 6,626,016 B2 are limited to two L-shaped aluminum block halves hinged together at a pivot end and locked together at an opposite end with a padlock enclosed in a padlock-body pocket of the two L-shaped aluminum block halves to which Applicant's invention is not limited.

Above-cited U.S. Pat. No. 6,705,137 B2 is limited to a rigid, one-piece hollow box to which Applicant's invention is not limited for receiving portions of a drive shaft, a crank shaft and an exposed lock shackle.

### SUMMARY OF THE INVENTION

Objects of patentable novelty and utility taught by this invention are to provide a shaft-lock system which:

locks a mechanism shaft to a shaft mechanism in a manner that prevents unwanted access to or use of the shaft mechanism;

prevents unwanted access to padlock shackles of a padlock with which the shaft-lock system is locked shut;

is light, easy to use, inexpensive and long lasting; and

can be used for locking a wide selection of classes of shaft-locking mechanisms, including but not limited to trailer jacks, trailer fifth wheels and gates.

This invention accomplishes these and other objectives with a shaft-lock system having a mechanism-shaft clamp with a first clamp jaw hinged to a second clamp jaw proximate a clamp pivot that is disposed oppositely from a clamp lock. The first clamp jaw and the second clamp jaw are articulated for enclosing a mechanism shaft cooperatively. The clamp lock includes a first-jaw indentation that is positioned on a lock end of the first clamp jaw for being juxtaposed to a second-jaw extension in a closed mode of the mechanism-shaft clamp. The first-jaw indentation includes an indentation aperture and the second-jaw extension includes an extension aperture that is concentrically collinear to the indentation aperture in the closed mode of the mechanism-shaft clamp. The extension aperture and the indentation aperture are articulated for receiving a lock shackle. Either clamp jaw includes a lock housing for housing the lock shackle and a lock for locking the lock shackle in the indentation aperture and in the extension aperture. The shaft-lock system includes a lock-shaft clamp having a lock-clamp axis juxtaposed parallel to a mechanism-clamp axis on the first clamp jaw and the second clamp jaw. The lock-shaft clamp is articulated for receiving a lock shaft for locking the lock shaft to the mechanism shaft.

### BRIEF DESCRIPTION OF DRAWINGS

This invention is described by appended claims in relation to description of a preferred embodiment with reference to the following drawings which are explained briefly as follows:

FIG. 1 is a top view of the shaft-lock system showing a shaft of a trailer-tongue jack as a mechanism shaft in a mechanism-shaft clamp and trailer-tongue crank as a lock shaft in a lock-shaft clamp;

FIG. 2 is a front view of the FIG. 1 illustration;

FIG. 3 is a top view of the shaft-lock system in open mode;

FIG. 4 is a front view of the FIG. 3 illustration;

FIG. 5 is a top view of an embodiment of the shaft-lock system for a two-shaft locking mechanism showing a first shaft and a second shaft locked together;

FIG. 6 is a top view of an embodiment of the shaft-lock system having an elongate lock-shaft clamp for receiving a non-parallel or distanced lock shaft;

FIG. 7 is a corner view of the FIG. 1 illustration through section line 1-1 of FIG. 1;

FIG. 8 is a corner view of the FIG. 1 illustration through section line 1-1 of FIG. 1 and showing optional lock-guard walls and hard-surface coating of an embodiment made of an aluminum alloy;

FIG. 9 is a corner view of the FIG. 1 illustration through section line 1-1 of FIG. 1 and showing optional lock-guard walls and made of steel alloyed for toughness, resistance to sawing with metal saws, resistance to cutting with metal cutters and having high tensile strength for low weight with thinness;

FIG. 10 is a fragmentary cutaway view of the shaft-lock system having first-jaw indentations and second-jaw extensions which are stepped;

FIG. 11 is a fragmentary cutaway view of the shaft-lock system having juxtaposed first-jaw indentations and second-jaw extensions;

FIG. 12 is a side view of the shaft-lock system with which a trailer crank is locked to a trailer-tongue jack;

FIG. 13 is a side view of the shaft-lock system locked to a fifth-wheel axle of a semitrailer tractor;

FIG. 14 is a top view of a juxtaposed embodiment of the shaft-lock system with thin structure of preferably hard and tough steel; and

FIG. 15 is a front view of the FIG. 14 illustration.

### DESCRIPTION OF PREFERRED EMBODIMENT

A description of the preferred embodiment of this invention follows a list of umbered terms which designate its features with the same numbers on the drawings and in parentheses throughout the description and throughout the patent claims.

1. Mechanism-shaft clamp

2. First clamp jaw

3. Second clamp jaw

4. Clamp pivot

5. Clamp lock

6. Mechanism shaft

7. Mechanism-shaft sides

8. First-jaw indentation

9. Second-jaw extension

10. Indentation aperture

11. Extension aperture

12. Lock shackle

13. Shackle-guard walls

14. Lock

15. First rod

16. Second rod

17. Lock-shaft clamp

18. First lock jaw

19. First lock-jaw extension

20. Second lock jaw

21. Second lock-jaw extension

22. Lock shaft

23. Trailer-tongue jack

24. Trailer-jack crank

25. Fifth-wheel axle

26. Restriction rod

27. First shaft

28. Second shaft

29. Lock-guard walls

30. Padlock body

31. First-jaw member

32. Second-jaw member

33. Down step

34. Up step

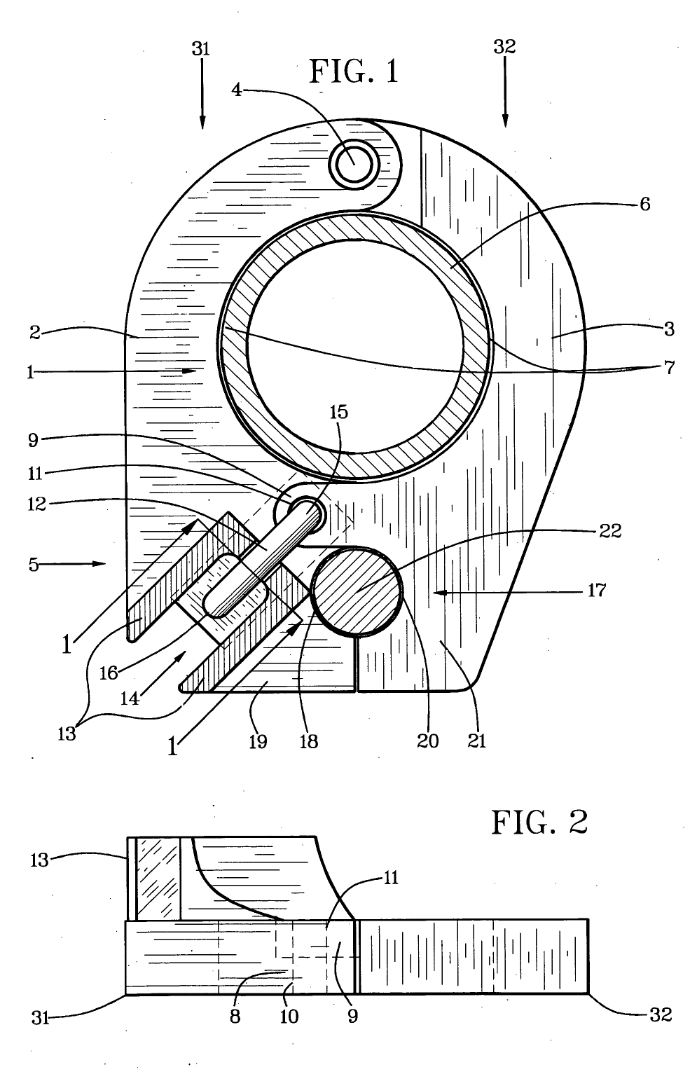

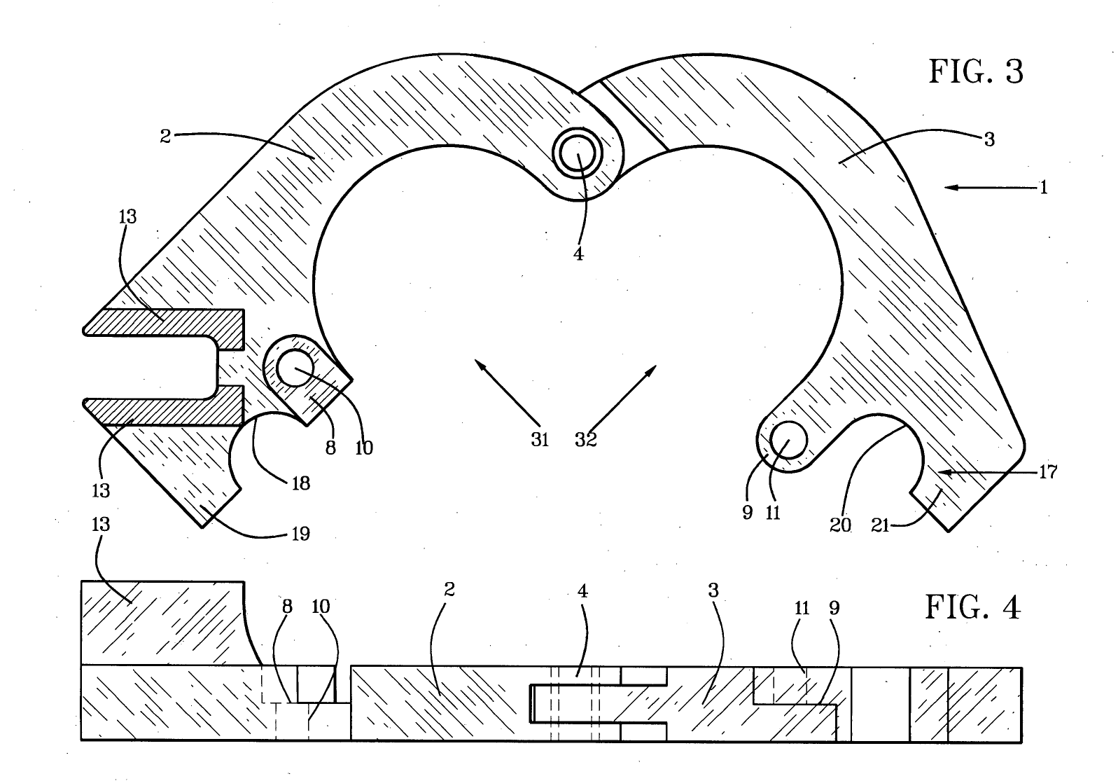

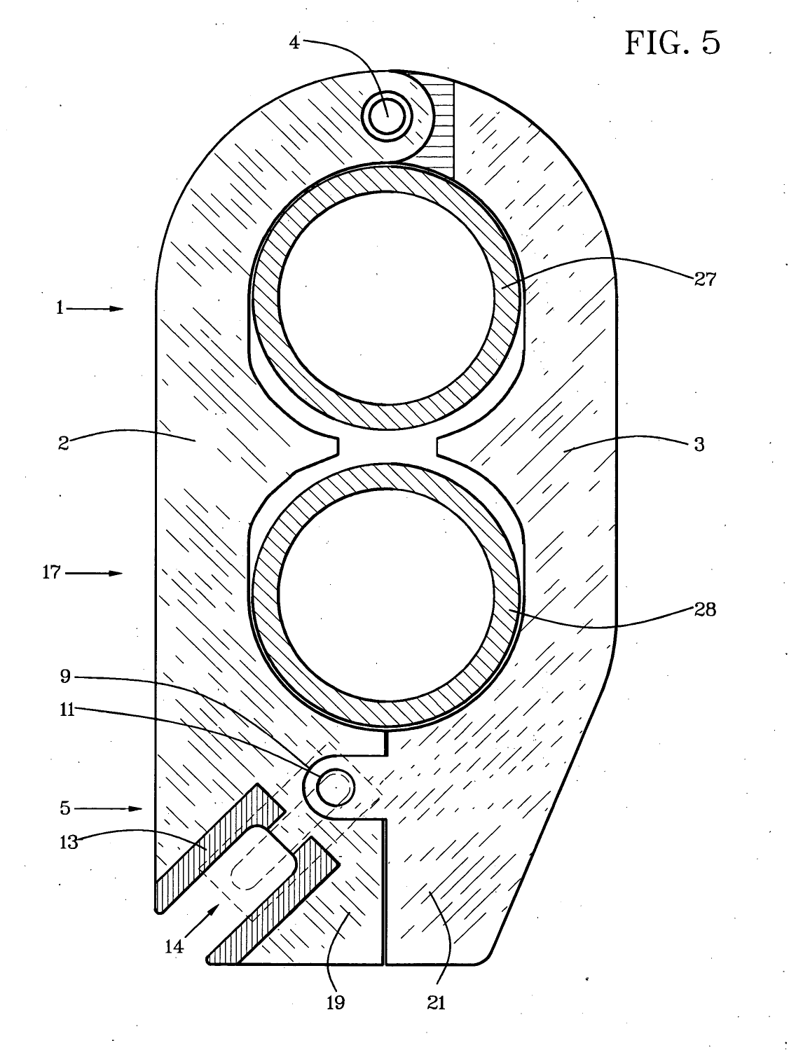

Referring to FIGS. 1-4, a mechanism-shaft clamp (1) has a first clamp jaw (2) hinged to a second clamp jaw (3) proximate a clamp pivot (4) that is disposed oppositely from a clamp lock (5). The first clamp jaw (2) and the second clamp jaw (3) are articulated for enclosing a mechanism shaft (6) cooperatively and for engaging mechanism-shaft sides (7) that are disposed oppositely.

The clamp lock (5) can include a first-jaw indentation (8) that is positioned on a lock end of the first clamp jaw (2) for being juxtaposed to a second-jaw extension (9) in a closed mode of the mechanism-shaft clamp (1). The first-jaw indentation (8) includes an indentation aperture (10) and the second-jaw extension (9) includes an extension aperture (11) that is concentrically collinear to the indentation aperture (10) in the closed mode of the mechanism-shaft clamp (1). The indentation aperture (10) and the extension aperture (11) are articulated for receiving a lock shackle (12) proximate the clamp lock (5).

The clamp lock (5) includes shackle-guard walls (13) extended orthogonally from the first clamp jaw (2) and articulated for guarding the lock shackle (12) of a lock (14) having a first rod (15) of the lock shackle (12) inserted through the indentation aperture (10) and the extension aperture (11). The shackle-guard walls (13) are extended laterally and articulated on the first clamp jaw (2) for receiving a second rod (16) of the lock shackle (12).

A lock-shaft clamp (17) can be juxtaposed parallel to the mechanism-shaft clamp (1). The lock-shaft clamp (17) has a first lock jaw (18) on a first lock-jaw extension (19) of the first clamp jaw (2). The lock-shaft clamp (17) has a second lockjaw (20) on a second lock-jaw extension (21) of the second clamp jaw (3).

The lock-shaft clamp (17) is articulated for receiving a predetermined lock shaft (22) intermediate the first lock jaw (18) and the second lock jaw (20).

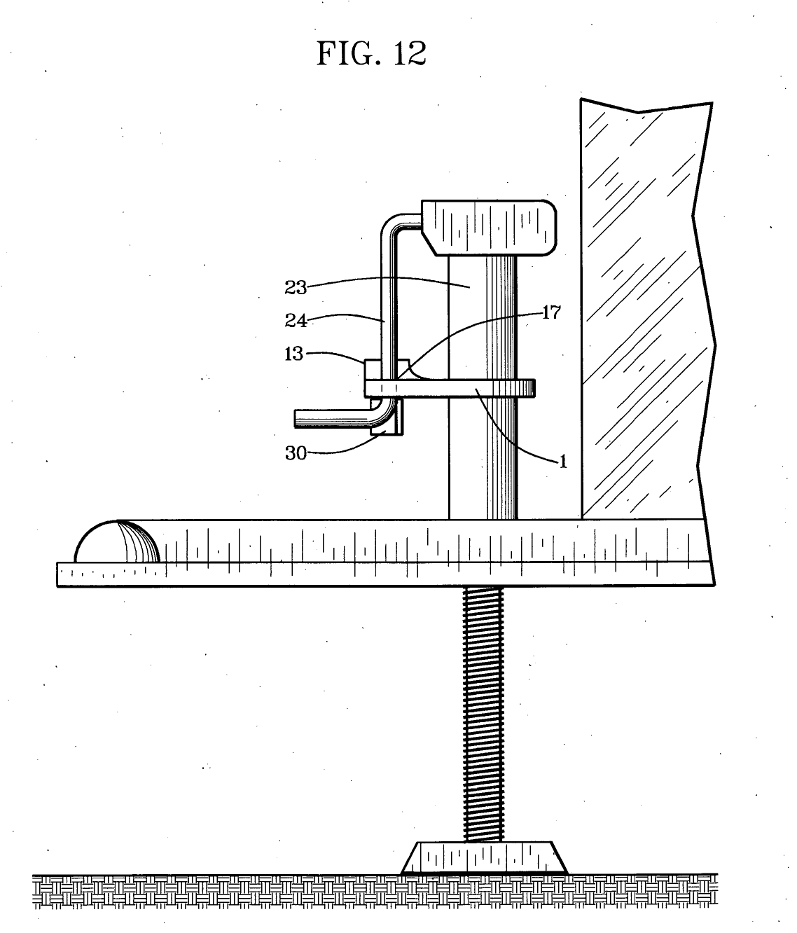

As shown in FIGS. 1 and 12, the mechanism-shaft clamp (1) can include articulation for clamping onto a cylindrical section of a trailer-tongue jack (23) and the lock-shaft clamp (17) can include articulation for clamping onto a section of a trailer-jack crank (24) intermediate the first lock jaw (18) and the second lock jaw (20) in the locked mode.

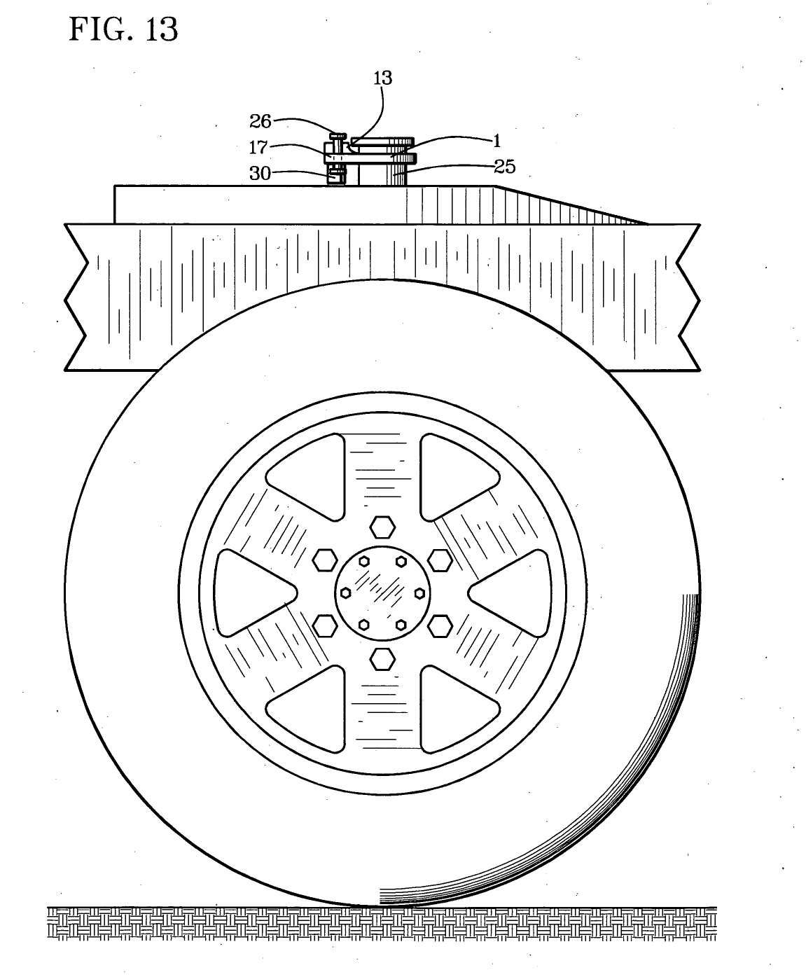

As shown in FIGS. 1 and 13, the mechanism-shaft clamp (1) can include articulation for receiving a fifth-wheel axle (25) for a semitrailer. Also, the lock-shaft clamp (17) can include articulation for receiving a section of a restriction rod 26).

As shown in FIG. 5, the mechanism-shaft clamp (1) can include articulation or receiving a section of a first shaft (27) of a two-shaft locking mechanism and the lock-shaft clamp (17) can include articulation for receiving a section of a second shaft (28) of the two-shaft locking mechanism in the locked mode.

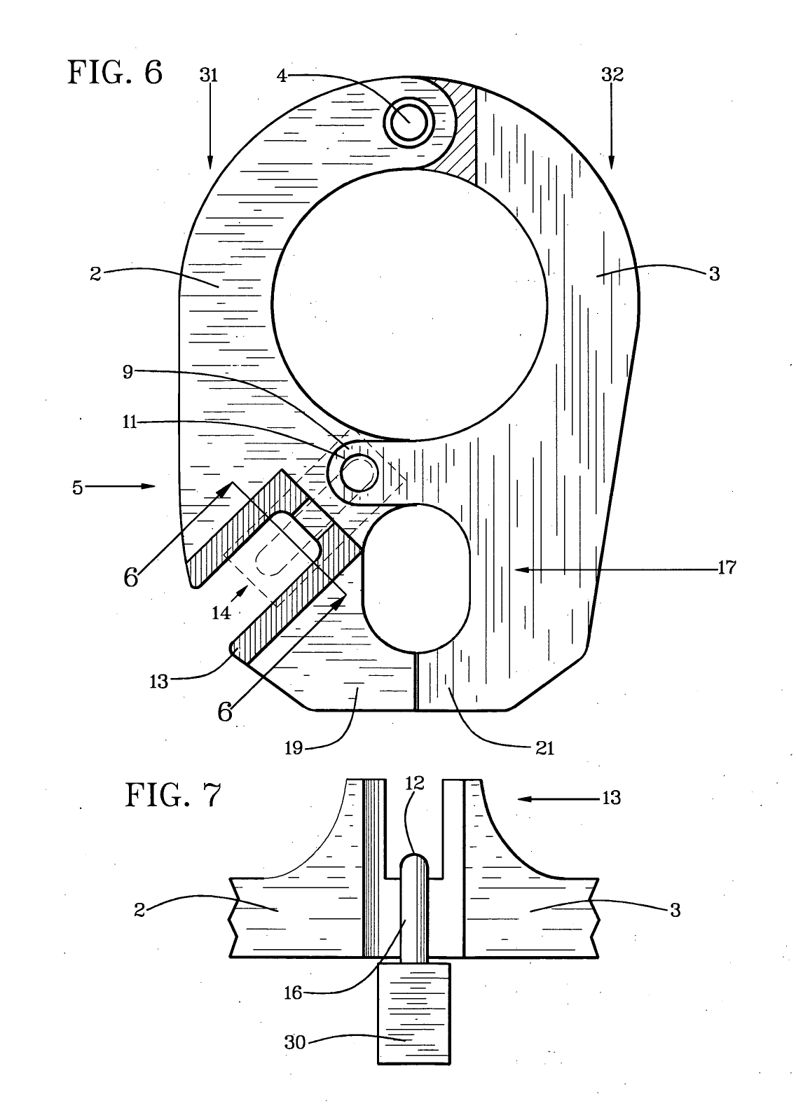

As shown in FIG. 6, the lock-shaft clamp (17) can be elongate for receiving a lock shaft (22) in a slanted mode or variously distanced from the mechanism shaft (6).

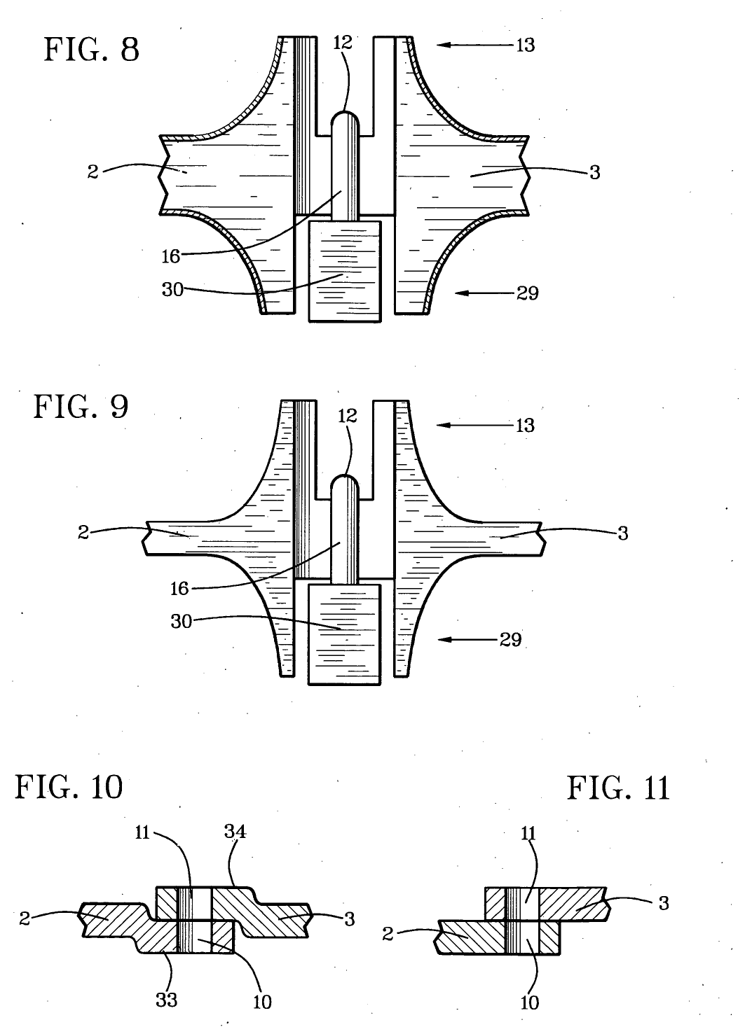

The shaft-lock system preferably includes structure with predetermined aluminum alloy. Aircraft-structural aluminum alloy in the 6000 range with a T-6 heat treatment and some piston aluminum alloys with copper can be used. As depicted in FIG. 8, the aluminum alloy can be coated with a predeterminedly hard material which can include metal or a cermet for deterring metal sawing and grinding.

The shaft-lock system can include structure with predetermined titanium alloy for lightness, but with greater cost. The titanium alloy also can be coated with a predeterminedly hard material for deterring metal sawing and grinding.

As depicted in FIG. 9, the structural material can include predetermined steel that is alloyed for toughness, resistance to sawing with metal saws, resistance to cutting with metal cutters and high tensile strength for low weight with thinness.

As shown in FIGS. 8-9, lock-guard walls (29) oppositely disposed from the shackle-guard walls (13) can be articulated for guarding a padlock body (30).

As shown also in FIGS. 1-4, the mechanism-shaft clamp (1) having the first clamp jaw (2) and the lock-shaft clamp (17) having the first lock jaw (18) can be positioned on a first-jaw member (31). Correspondingly, the mechanism-shaft clamp (1) having the second clamp jaw (3) and the lock-shaft clamp (17) having the second lock jaw (20) can be positioned on a second-jaw member (32).

The first-jaw member (31), the second-jaw member (32) and the clamp pivot (4) preferably have axes that are parallel with the first clamp jaw (2) and the second clamp jaw (3).

As depicted in FIG. 10, the first-jaw indentation (8) can include a down step (33) and the second-jaw extension (9) can includes an up step (34).

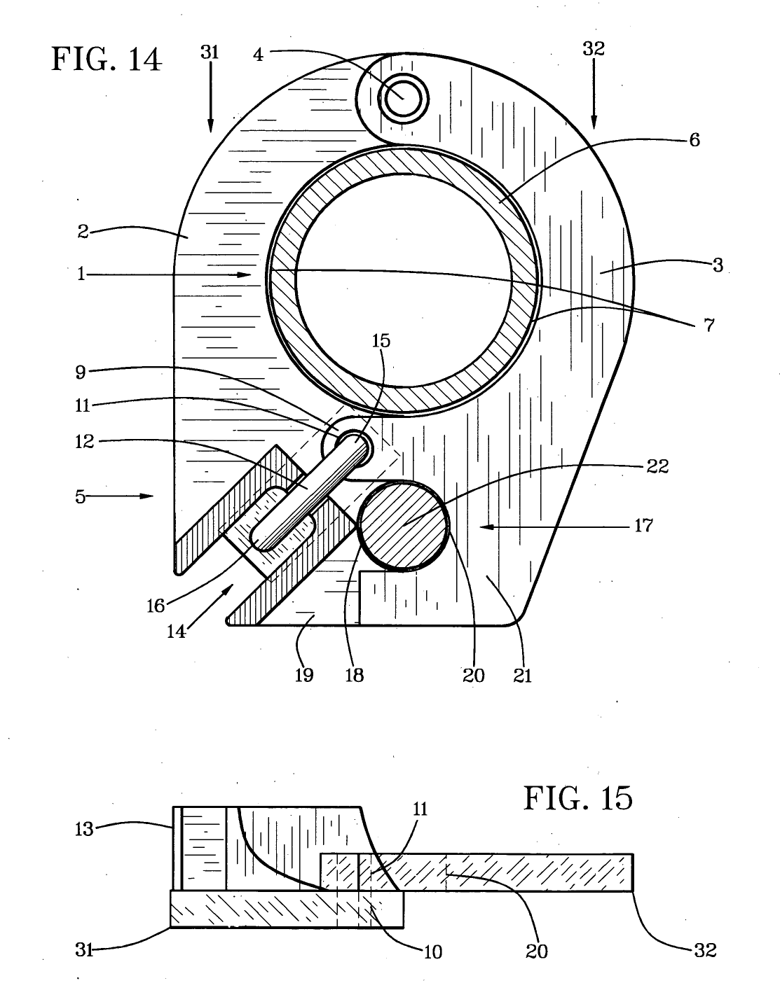

Referring to FIGS. 11 and 14-15, the first-jaw member (31) can be juxtaposed to the second-jaw member (32) proximate the clamp pivot (4) for a juxtaposed embodiment. The first clamp jaw (2) of the mechanism-shaft clamp (1) and the first lockjaw (18) of the lock-shaft clamp (17) are positioned on the first-jaw member (31). The second clamp jaw (3) of the mechanism-shaft clamp (1) and the second lockjaw (20) of the lock-shaft clamp (17) are positioned on the second-jaw member (32).

The indentation aperture (10) can be in the lock end of the first-jaw member (31). The extension aperture (11) can be in the lock end of the second-jaw member (32) with the indentation aperture (10) and the extension aperture (11) being articulated for receiving the lock shackle (12) proximate the clamp lock (5).

The clamp lock (5) can include the shackle-guard walls (13) extended orthogonally from the first clamp jaw (2) and articulated for guarding the lock shackle (12) of the lock (14) having the first rod (15) of the lock shackle (12) inserted through the indentation aperture (10) and the extension aperture (11).

The shackle-guard walls (13) are extended laterally and articulated on the first clamp jaw (2) for receiving the second rod (16) of the lock shackle (12).

A new and useful shaft-lock system having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A shaft-lock system comprising:
a mechanism-shaft clamp with a first clamp jaw hinged to a second clamp jaw proximate a clamp pivot that is disposed oppositely from a clamp lock;
the first clamp jaw and the second clamp jaw being articulated for enclosing mechanism shaft cooperatively;
the first clamp jaw and the second clamp jaw being articulated for arresting mechanism-shaft sides;
the clamp lock includes a first-jaw indentation that is positioned on a lock end of the first clamp jaw for being juxtaposed to a second-jaw extension in a closed mode of the mechanism-shaft clamp;
the first-jaw indentation includes an indentation aperture and the second-jaw extension includes an extension aperture that is concentrically collinear to the indentation aperture in the closed mode of the mechanism-shaft clamp;
the indentation aperture and the extension aperture being articulated for receiving a lock shackle proximate the clamp lock;
the clamp lock includes shackle-guard walls extended orthogonally from the first clamp jaw and articulated for guarding the lock shackle of a lock having a first rod of the lock shackle inserted through the indentation aperture and the extension aperture;
the shackle-guard walls being extended laterally and articulated on the first clamp jaw for receiving a second rod of the lock shackle;
a lock-shaft clamp juxtaposed parallel to the mechanism-shaft clamp;
the lock-shaft clamp having a first lock jaw on a first lock-jaw extension of the first clamp jaw;
the lock-shaft clamp having a second lockjaw on a second lock-jaw extension of the second clamp jaw; and
the lock-shaft clamp being articulated for receiving a predetermined lock shaft intermediate the first lock jaw and the second lock jaw.

2. The shaft-lock system of claim 1 wherein:
the mechanism-shaft clamp includes articulation for clamping onto a cylindrical section of a trailer-tongue jack.

3. The shaft-lock system of claim 2 wherein:
the lock-shaft clamp includes articulation for clamping onto a section of a trailer-jack crank intermediate the first lock jaw and the second lock jaw in the locked mode.

4. The shaft-lock system of claim 1 wherein:
the mechanism-shaft clamp includes articulation for receiving a fifth-wheel axle for a semitrailer.

5. The shaft-lock system of claim 1 wherein:
the lock-shaft clamp includes articulation for receiving a section of a restriction rod.

6. The shaft-lock system of claim 1 wherein:
the mechanism-shaft clamp includes articulation for receiving a section of a first shaft of a two-shaft locking mechanism; and
the lock-shaft clamp includes articulation for receiving a section of a second shaft of the two-shaft locking mechanism in the locked mode.

7. The shaft-lock system of claim 1 includes structure with predetermined aluminum alloy.

8. The shaft-lock system of claim 7 wherein the aluminum alloy is coated with a predeterminedly hard material for deterring metal sawing and grinding.

9. The shaft-lock system of claim 1 includes structure with predetermined titanium alloy.

10. The shaft-lock system of claim 9 wherein the titanium alloy is coated with a predeterminedly hard material for deterring metal sawing and grinding.

11. The shaft-lock system of claim 1 includes structure with predetermined steel that is alloyed for toughness, resistance to sawing with metal saws, resistance to cutting with metal cutters and high tensile strength for low weight with thinness.

12. The shaft-lock system of claim 1 and further comprising:
lock-guard walls oppositely disposed from the shackle-guard walls and articulated for guarding a padlock body.

13. The shaft-lock system of claim 1 wherein:
the first-jaw indentation includes a down step; and
the second-jaw extension includes an up step.

14. A shaft-lock system comprising:
a first-jaw member and a second-jaw member having the clamp pivot;
the mechanism-shaft clamp having the first clamp jaw and the lock-shaft clamp having the first lock jaw on the first-jaw member;
the mechanism-shaft clamp having the second clamp jaw and the lock-shaft clamp having the second lock jaw on the second-jaw member;
the first-jaw member, the second-jaw member and the clamp pivot having axes that are parallel;
the first clamp jaw and the second clamp jaw being articulated for enclosing a predetermined mechanism shaft cooperatively;
the lock-shaft clamp being articulated for receiving a predetermined lock shaft cooperatively intermediate the first lock jaw and the second lock jaw;
the clamp lock including the first-jaw indentation that is positioned and articulated on the lock end of the first clamp jaw for being juxtaposed to a second-jaw extension on the lock end of the second clamp jaw in the closed mode;
the first-jaw indentation includes the indentation aperture and the second-jaw extension includes the extension aperture that is concentrically collinear to the indentation aperture in the closed mode of the mechanism-shaft clamp;
the indentation aperture and the extension aperture being articulated for receiving the lock shackle proximate the clamp lock;
the clamp lock includes shackle-guard walls extended orthogonally from the first clamp jaw and articulated for guarding the lock shackle of the lock having the first rod of the lock shackle inserted through the indentation aperture and the extension aperture; and
the shackle-guard walls being extended laterally and articulated on the first clamp jaw for receiving the second rod of the lock shackle.

15. The shaft-lock system of claim 14 wherein:
the mechanism-shaft clamp includes articulation for receiving a cylindrical section of a trailer-tongue jack intermediate an arcuate portion of the first clamp jaw and an arcuate portion of the second clamp jaw.

16. The shaft-lock system of claim 15 wherein:
the lock-shaft clamp includes articulation for receiving a section of a trailer-jack crank intermediate the first lock jaw and the second lock jaw in the locked mode.

17. The shaft-lock system of claim 14 wherein:
the mechanism-shaft clamp includes articulation for receiving a fifth-wheel axle for a semitrailer.

18. The shaft-lock system of claim 14 wherein:
the lock-shaft clamp includes articulation for receiving a section of a restriction rod.

19. The shaft-lock system of claim 14 wherein:
the mechanism-shaft clamp includes articulation for clamping onto a section of a first shaft of a two-shaft locking mechanism; and
the lock-shaft clamp includes articulation for clamping onto a section of a of a second shaft of the two-shaft locking mechanism in the locked mode.

20. The shaft-lock system of claim 14 includes structure with predetermined aluminum alloy.

21. The shaft-lock system of claim 20 wherein the aluminum alloy is coated with a predeterminedly hard material for deterring metal sawing and grinding.

22. The shaft-lock system of claim 14 includes structure with predetermined steel that is alloyed for toughness, resistance to sawing with metal saws, resistance to cutting with metal cutters and high tensile strength for low weight with thinness.

23. The shaft-lock system of claim 14 and further comprising:
lock-guard walls oppositely disposed from the shackle-guard walls and articulated for guarding the padlock body.

24. The shaft-lock system of claim 14 wherein:
the first-jaw indentation includes a down step; and
the second-jaw extension includes an up step.

25. A shaft-lock system comprising:
the first-jaw member juxtaposed to the second-jaw member proximate the clamp pivot;
the first clamp jaw of the mechanism-shaft clamp and the first lockjaw of the lock-shaft clamp being on the first-jaw member;
the second clamp jaw of the mechanism-shaft clamp and the second lock jaw of the lock-shaft clamp being on the second-jaw member;
the indentation aperture being in the lock end of the first-jaw member;
the extension aperture being in the lock end of the second-jaw member;
the indentation aperture and the extension aperture being articulated for receiving the lock shackle proximate the clamp lock;
the clamp lock includes shackle-guard walls extended orthogonally from the first clamp jaw and articulated for guarding the lock shackle of the lock having the first rod of the lock shackle inserted through the indentation aperture and the extension aperture; and
the shackle-guard walls being extended laterally and articulated on the first clamp jaw for receiving the second rod of the lock shackle.

26. The shaft-lock system of claim 25 and further comprising:
lock-guard walls oppositely disposed from the shackle-guard walls and articulated for guarding the padlock body.
